(19) United States
(12) Patent Application Publication
(10) Pub. No.: US 2007/0281562 A1
(43) Pub. Date: Dec. 6, 2007

(54) Building construction composite having one or more reinforcing scrim layers

(76) Inventors: Randolph S. Kohlman, Boiling Springs, SC (US); W. Randolph Hursey, Tryon, NC (US); Philbrick Allen, Simpsonville, SC (US); Dimple P. Desai, Greer, SC (US)

Correspondence Address: Legal Department (M-495), P.O. Box 1926, Spartanburg, SC, 29304, US

(21) Appl. No.: 11/445,895

(22) Filed: Jun. 2, 2006

(51) Int. Cl. B32B 5/26

(52) U.S. Cl. 442/32; 442/6; 442/49; 442/20; 442/24; 442/29; 442/35; 442/43

(57) ABSTRACT

The present disclosure is directed to a composite useful as a building construction material, in which one or more textile scrims are attached to a nonwoven mat. In one embodiment, a high elongation scrim layer and a low elongation scrim layer are attached to a nonwoven mat to provide high impact resistance and enhanced structural support. In a second embodiment, a nonwoven mat is reinforced with a single scrim layer having both high elongation and low elongation yarns to form a composite. The scrim layers are preferably adhesively bonded laid scrims, although other scrim types or combinations thereof may also be used. Preferably, the high elongation material is made of polyester, the low elongation material is made of glass, and the nonwoven mat is made of polypropylene. The resulting functional composite may be used as a housewrap or roofing reinforcement on vertical, horizontal, or angular exterior surfaces.

### TECHNICAL FIELD

The present disclosure is directed to a composite material useful in building construction, in which the composite has one or more reinforcing scrim layers that are attached to a vapor permeable membrane (such as a nonwoven mat). In one embodiment, the composite has a high elongation scrim layer and a low elongation scrim layer, which are attached to a nonwoven mat. In a second embodiment, a nonwoven mat is joined to a single reinforcing scrim having both high elongation yarns and low elongation yarns. These composites, which are particularly useful as a housewrap or a roofing substrate material, exhibit high impact resistance and enhance the structural support of the building in which they are used.

### BACKGROUND

Historically, housewrap has been applied to the exterior of new building construction to perform two functions: to prevent airflow through a wall and to stop water that has penetrated through the exterior siding. Housewrap serves as a dual-function weather barrier, which minimizes the flow of air in and out of a house and also stops liquid water from entering the house (where it can seep into the framing and cause rot). The unique characteristic of housewrap is that it forms a vapor permeable membrane, allowing humid air to escape from inside the house, while preventing liquid water (for instance, rain) from entering the house. According to some estimates, the average household produces between three and six gallons of moisture a day from showering, cooking, and the like, which are preferably allowed to flow through the housewrap to the outside rather than settling in the walls of the house. In many climates, housewrap has proven more effective than building paper and, as a result, has replaced building paper in new construction.

During construction, housewrap is attached to the framing of the house with nails or screws. It is recommended that adjacent pieces of housewrap overlap one another by six inches on wall surfaces and by twelve inches at corners. Housewrap must be weather resistant (that is, able to endure high winds and inclement weather) and must be puncture and tear resistant, so that it is not compromised during installation. Tears or holes in the housewrap-provide openings for water to leak into the house, which can lead to damage over time.

Structurally, typical housewraps are made of a nonwoven polymer mat that may be attached to a layer of film. While such constructions have been sufficient for their intended purposes, manufacturers recently have expressed an interest in having a housewrap that is both impact resistant and which also can provide structural support to the house. In areas that are prone to extreme weather, such as tornados and hurricanes, houses may be subjected to damage from high winds, heavy rains, and flying debris.

Ordinarily, the exterior siding of a home bears the brunt of such harsh conditions. However, to provide further protection against flying debris—for example, building materials or tree limbs that are propelled by high winds from a storm system—manufacturers have expressed a desire for a housewrap with high impact resistance. Such a housewrap would prevent debris from penetrating through an interior wall. In this instance, the ability to absorb energy is desirable so that the housewrap absorbs the impact from the debris without snapping, as might happen if the housewrap were brittle.

A second goal of an improved housewrap is to provide structural support to a house by wrapping around and securing the framing members in their relative positions. Such a configuration prevents the framing members from separating in the event of wind shears, which would ordinarily pull the upper framing members away from the lower framing members. In this instance, strength at low elongation is the most desired characteristic, and flexibility negatively affects the housewrap's ability to meet this goal.

The present disclosure addresses these contradictory goals by providing a composite having vapor permeable membrane (preferably, a nonwoven mat) that is reinforced by one or more scrim layers, where the scrim layer(s) provide to the composite both energy absorption and strength at low elongation. In a first embodiment, two scrim layers are used, a first scrim layer exhibiting high elongation (energy absorption) and a second scrim layer exhibiting low elongation and high tensile strength. In a second embodiment, high elongation yarns and low elongation yarns are used in the same scrim material to meet these dual needs of flexibility and strength.

### SUMMARY

The present disclosure is directed to a composite useful as a building construction material, in which one or more textile scrims are attached to a vapor permeable membrane (such as a nonwoven mat). In one embodiment, a high elongation scrim layer and a low elongation scrim layer are attached to a nonwoven mat to provide high impact resistance and enhanced structural support. In a second embodiment, a nonwoven mat is reinforced with a single scrim layer having both high elongation and low elongation yarns to form a composite. The scrim layers are preferably adhesively bonded laid scrims, although a thermally bonded laid scrim, a weft-inserted warp knit scrim, a multi-axial knit scrim, a woven scrim, a cross-plied scrim, a stitch-bonded scrim, or combinations thereof may also be used. Preferably, the high elongation material is made of polyester, the low elongation material is made of glass, and the nonwoven mat is made of polypropylene. The resulting functional composite may be used as a housewrap or roofing reinforcement on vertical, horizontal, or angular exterior surfaces.

### BRIEF DESCRIPTION OF THE DRAWINGS

FIG. 1 is a plan view of a tri-axial scrim material, preferably used in the present composite;

FIG. 2A is an exploded view of a composite according to a first embodiment provided herein, comprising a nonwoven mat, a first layer of low elongation scrim material, and a second layer of high elongation scrim material;

FIG. 2B is an exploded view of an alternate composite construction according to the first embodiment provided herein, comprising a nonwoven mat, a first layer of high elongation scrim material and a second layer of low elongation scrim material;

FIG. 2C is an exploded view of yet another alternate composite construction according to the first embodiment provided herein, comprising a nonwoven mat, two layers of low elongation scrim material, and a third layer of high elongation material;

FIG. 3 is an exploded view of a composite according to a second embodiment provided herein, comprising a single layer of scrim material having yarns of different elongation and a nonwoven mat; and

FIG. 4 is an exploded view of a composite according to a third embodiment provided herein, comprising a nonwoven mat that is positioned between a high elongation scrim material and a low elongation scrim material.

### DETAILED DESCRIPTION

The present disclosure is directed to a building construction composite that is vapor permeable and that exhibits high strength. There are several commercially available housewrap products currently on the market, which generally are satisfactory for weather-proofing purposes, but which do not fully address the issue of impact resistance.

DuPont manufactures a flash-spun nonwoven material made with high-density, randomly oriented polyethylene, which is sold under the tradename TYVEK® HomeWrap®. This material, which weighs about 1.8 oz/yd², provides a breathable weather resistant barrier for the underlying house frame. Reemay, Inc., a member of BBA Nonwovens, markets a different housewrap material under the tradename TYPAR® HouseWrap. This material, which weighs about 3.1 oz/yd² and has a thickness of 12.9 mils, is formed from a spun-bonded polypropylene that has been coated with a moisture-permeable coating. These are but two examples of commercially available products.

Both the TYVEK® and TYPAR® housewraps are typically installed by wrapping rolls of the material horizontally around the framing of the house to protect the house from damage due to weather exposure. These housewraps have a width of from 3 feet wide to 10 feet wide and lengths of from 50 feet to 200 feet. Key components of these housewraps are that they are vapor permeable (allowing water vapor to pass through from the interior of the home to the outside) and simultaneously are water-resistant (preventing water from entering the house and being absorbed by the framing).

However, none of the existing housewraps has been engineered for impact resistance (that is, high strength at low elongation). The present composite provides such additional functionality, while maintaining the desired water impermeability and vapor permeability characteristics.

As used herein, the term “scrim” shall mean a fabric having an open construction used as a base fabric or a reinforcing fabric, which may be manufactured as an adhesively or thermally bonded laid scrim, a woven scrim, a weft-inserted warp knit scrim, a multi-axial knit scrim, a stitch-bonded scrim, or a cross-plied scrim. To make the present composite structures, one or more scrims are attached to a vapor permeable membrane, using any of a number of commercially known techniques, many of which will be described herein.

In one manufacturing technique, for example, a scrim may be attached to a carrier layer, such as a film or a fabric mat, during manufacture and then be attached to a vapor permeable membrane (such as a nonwoven mat) to produce the present composite structure. Alternately, as will be further described herein, a scrim may be stitch-bonded directly to a vapor permeable membrane.

The open nature of a scrim construction preserves the moisture vapor transmission properties of the composite, which are especially important in housewrap applications, while adding strength and impact resistance. The open structure of a scrim fabric also facilitates the ease with which the scrim may be incorporated into a composite structure, such as a housewrap or roofing reinforcement. Particularly in those applications where an adhesive is used to bond multiple layers, the openness of the scrim allows adhesive flow-through, which results in a stronger bond between the composite components.

Scrims, as described herein, contain at least one set of warp yarns and at least one crossing, or weft, yarn. Generally speaking, the warp yarn set contains between about 0.5 yarns per inch and about 32 yarns per inch; more preferably, the warp yarn set contains between about 1 yarn per inch and about 16 yarns per inch; and most preferably, the warp yarn set contains between about 1 yarn per inch and about 12 yarns per inch. The number of yarns per inch provided above refers to warps made from low elongation yarns (such as fiberglass). When high elongation yarns (such as polyester) are used in the warp direction, the maximum number of yarns in the warp yarn set is more likely 16 yarns per inch.

The warp yarn density may be determined by any of a number of factors, including, for instance, the tensile requirements of the final composite. For the applications contemplated herein (that is, building construction materials), scrim constructions that result in high tensile strength are preferred. It should be understood that the desired yarn density is achievable by any of a number of acceptable methods, such as providing a single scrim layer with the appropriate number of yarns, providing two or more scrim layers whose aggregate number of yarns falls into the desired range, and providing one or more scrim layers with bundles of yarns whose size provides the desired density. As an alternative to using bundles of yarns, yarns of a larger size may also be used.

Preferably, the crossing yarn is present at a spacing of between about 0.5 yarns per inch and 32 yarns per inch; more preferably, the crossing yarn is present at between about 1 yarn per inch and 16 yarns per inch; and most preferably, the crossing yarn is present at between about 1 yarn per inch and 12 yarns per inch. It should be understood that the crossing yarn spacing may be achieved by positioning multiple fibers on the warp yarn set or by positioning a single fiber, so that it curves back and forth across the width of the fabric, as will be described further herein.

The yarns useful in the present scrim layers may be selected from any commercially available yarns known in the art, including spun yarns, multi-filament yarns, and tape yarns. Examples of suitable low elongation yarns include those made of ceramic, fiberglass, basalt, carbon, aramid, metal, and combinations thereof. Examples of suitable high elongation yarns include those made of polyester, polyamides, polyolefin, and combinations thereof. The yarns may additionally be twisted, covered, and/or plied. They optionally may be single component or bi-component yarns, such as sheath-core fibers with a low-melt adhesive material in the sheath.

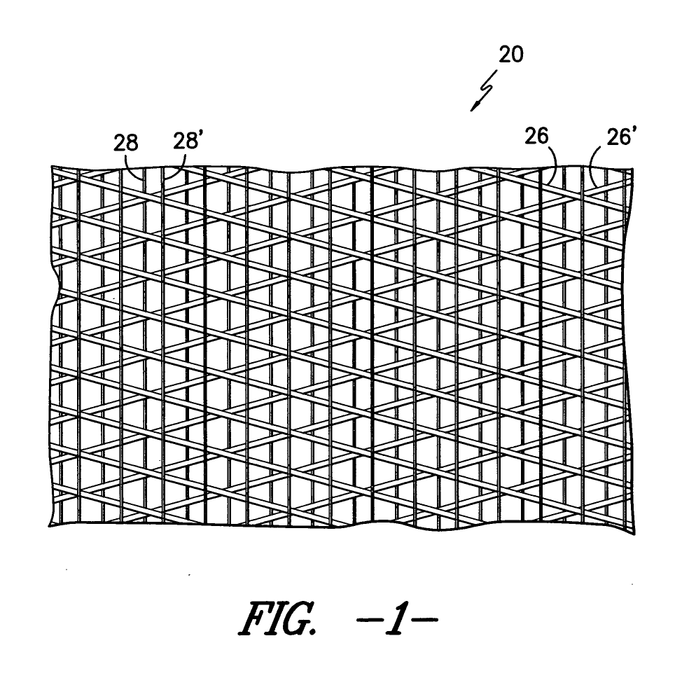

There are a variety of fabric formation technologies that can provide a scrim fabric suitable for use in the present composite as a building construction material. One preferred method involves forming an adhesively bonded scrim, where the adhesive applied to hold the scrim yarns in place also bonds the scrim to the vapor permeable membrane (e.g., a nonwoven mat). The yarns are laid as will be described below (with reference to a tri-axial scrim) and are then adhesively bonded at their interstices to form a stable scrim material, illustrated in FIG. 1 as scrim 20.

Shown in a preferred construction in FIG. 1, reinforcement fabric 20 is a tri-directional, or tri-axial, scrim fabric that is held together by an adhesive composition or by thermal bonding. When the scrim is adhesively bonded, the adhesive coating of reinforcement fabric 20 is dried after application to stabilize reinforcement fabric 20. Alternately, thermal bonding may be used.

In a tri-axial construction, there are multiple sets of yarns: two sets of weft yarns 26, 26′, a first set 26 having a downward (left-to-right) diagonal slope and a second set 26′ having an upward (left-to-right) diagonal slope, and a set of longitudinal warp yarns 28, 28′ that are located on either side of the weft yarns 26, 26′.

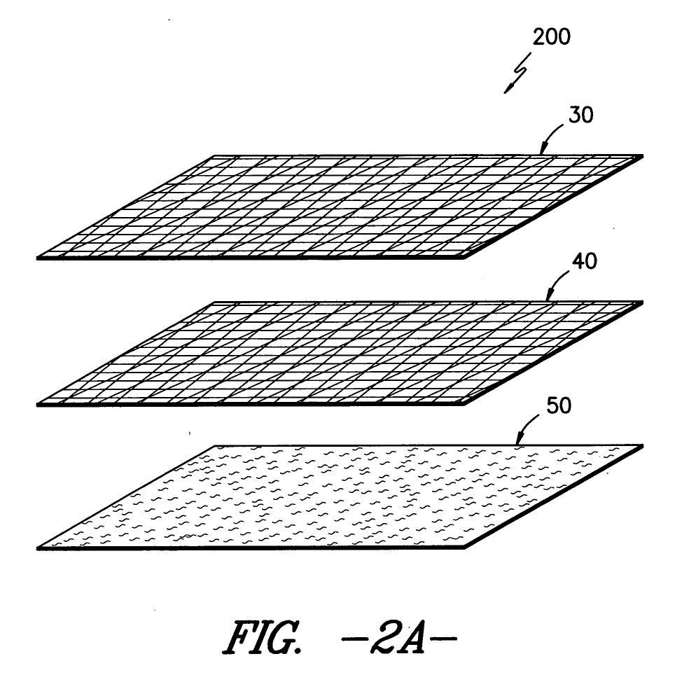

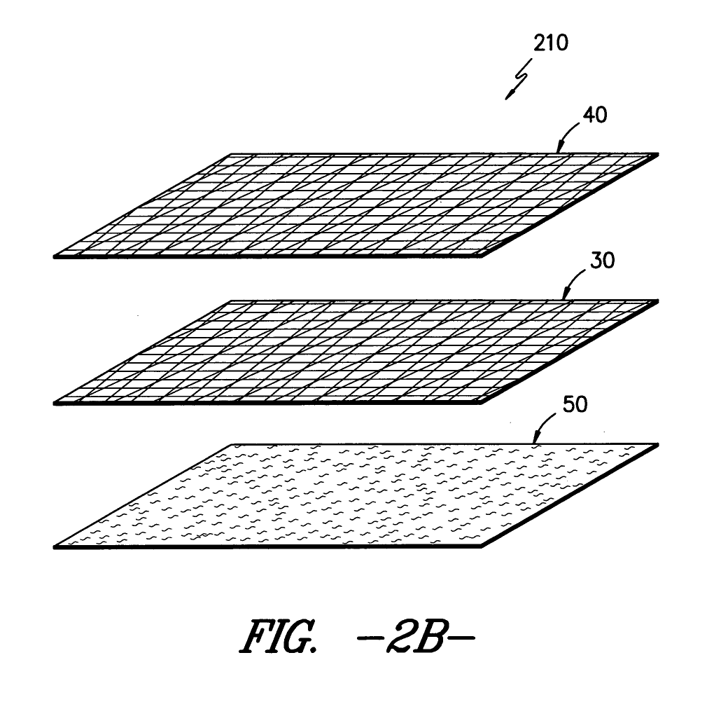

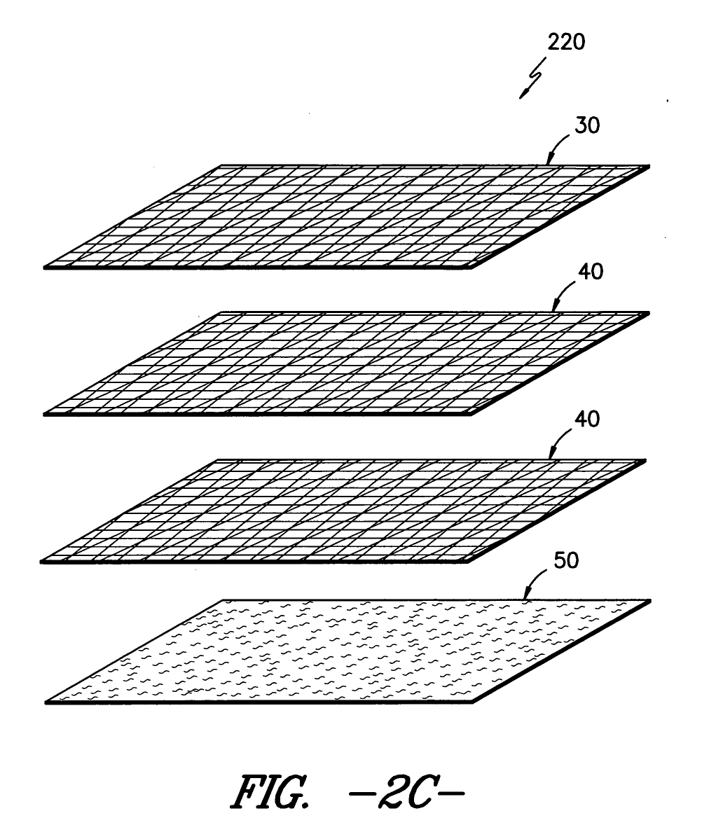

In the production of a low elongation scrim (identified in FIGS. 2A-4 as scrim 40), the preferred range of the fabric construction is between approximately 2×1×1 (2 ends per inch in the warp direction, 1 end per inch on the upward diagonal slope in the weft direction, and 1 end per inch on the downward diagonal slope in the weft direction) and 32×16×16 (32 ends per inch in the warp direction, 16 ends per inch on the upward diagonal slope in the weft direction, and 16 ends per inch on the downward diagonal slope in the weft direction), and is most preferably between 6×3×3 (6 ends per inch in the warp direction, 3 ends per inch on the upward diagonal slope in the weft direction, and 3 ends per inch on the downward diagonal slope in the weft direction) and 16×8×8 (16 ends per inch in the warp direction, 8 ends per inch on the upward diagonal slope in the weft direction, and 8 ends per inch on the downward diagonal slope in the weft direction).

Further, the warp yarns 28, 28′ and weft yarns 26, 26′ are preferably fiberglass. Glass strand filaments are characterized using a number of different designations, which include a letter that refers to the diameter of the filament and a number that refers to the number of hundreds of yards of filament per pound (for example, a G-150 yarn has a diameter of between 8.9 microns and 10.15 microns and has 15,000 yards per pound).

Preferably, fiberglass filaments having a diameter ranging from BC (3.5 microns) to K (14 microns) are used. More preferably, G and H size yarns are used, having a size of from G-150 to H-18; even more preferably, a size in the range of G-75 to H-18; and most preferably, having a size of G-37 or H-18.

In the production of a high elongation scrim (identified in FIGS. 2A-4 as scrim 30), the preferred range of the fabric construction is between approximately 16×8×8 (16 ends per inch in the warp direction, 8 ends per inch on the upward diagonal slope in the weft direction, and 8 ends per inch on the downward diagonal slope in the weft direction) and 2×1×1 (2 ends per inch in the warp direction, 1 end per inch on the upward diagonal slope in the weft direction, and 1 end per inch on the downward diagonal slope in the weft direction), and is most preferably 8×2×2 (8 ends per inch in the warp direction, 2 ends per inch on the upward diagonal slope in the weft direction, and 2 ends per inch on the downward diagonal slope in the weft direction). The high elongation scrim is preferably made of high-tenacity, low-shrink polyester yarns having a denier in the range of between 500 denier to 1,500 denier and, more preferably, a denier of about 1000 denier. The elongation of the yarns is preferably a minimum of 20% at break. While the above paragraphs describe preferred ranges of yarn sizes, it is to be understood that the denier of the warp yarns determines the strength of the scrim, and the yarns may be chosen to enhance reinforcement of the scrim material. Therefore, yarns of any denier or size may be used, as may meet the strength requirements of the product (i.e., either the scrim or a composite containing the scrim). Yarns from the high elongation scrim and the low elongation scrim will both contribute to the strength of the final composite, but the high elongation scrim will contribute less strength at low elongation, because the material itself possesses a high elongation.

In the production of a combined scrim—that is, a scrim having both high elongation yarns and low elongation yarns—the preferred range of the fabric construction is between approximately 32×16×16 (32 ends per inch in the warp direction, 16 ends per inch on the upward diagonal slope in the weft direction, and 16 ends per inch on the downward diagonal slope in the weft direction) and 2×1×1 (2 ends per inch in the warp direction, 1 end per inch on the upward diagonal slope in the weft direction, and 1 end per inch on the downward diagonal slope in the weft direction), and is most preferably between 16×8×8 (16 ends per inch in the warp direction, 8 ends per inch on the upward diagonal slope in the weft direction, and 8 ends per inch on the downward diagonal slope in the weft direction) and 4×2×2 (4 ends per inch in the warp direction, 2 ends per inch on the upward diagonal slope in the weft direction, and 2 ends per inch on the downward diagonal slope in the weft direction). In this instance, the low elongation (e.g., glass) yarns are preferably placed in the warp direction, and the high elongation (e.g., polyester) yarns are preferably placed in the weft directions. Alternately, high elongation yarns and low elongation yarns may both be used in the warp direction.

While a tri-axial scrim construction has been illustrated and is believed to be most preferred for all of the scrim layers, it should be understood that bi-axial or multi-axial scrims may be combined with a vapor permeable membrane (such as a nonwoven mat), in accordance with the teachings herein, as the desired functional attributes of the composite dictate. In some circumstances, it may be desirable to use scrim materials of different constructions in combination with a vapor permeable membrane.

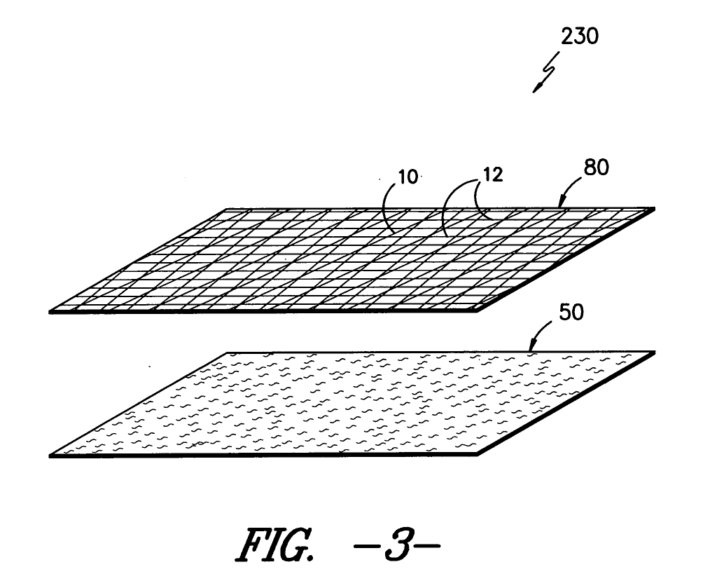

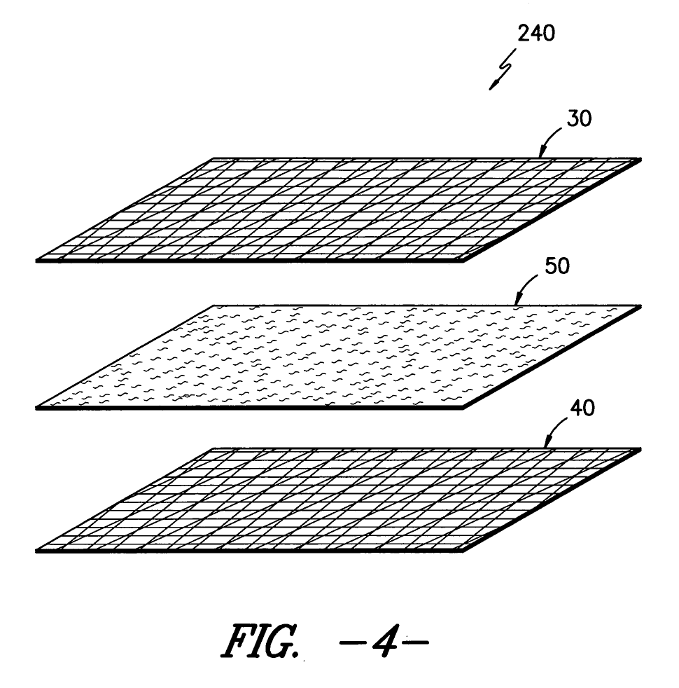

In a first embodiment, which is illustrated in FIGS. 2A, 2B, and 4, a first scrim layer 30 having high elongation yarns (for example, polyester), a second scrim layer 40 having low elongation yarns (for example, fiberglass), and a nonwoven mat 50 are attached to one another to form a composite. A composite having a single layer of high elongation scrim 30 and two layers of low elongation scrim 40 is shown in FIG. 2C. In a second embodiment, which is illustrated in FIG. 3, low elongation yarns 10 and high elongation yarns 12 are combined into the same scrim material 80, preferably with one material in the warp and a second material in the weft, and more preferably using high elongation yarns 12 that have been heat-stabilized.

As an alternative to the tri-axial scrim discussed above, a bidirectional scrim may be produced, having one or more crossing (weft) yarns that are positioned substantially perpendicularly to two sheets of warp yarns, which are positioned on either side of the weft yarn(s). In this instance, the cross-machine direction yarns are inserted between the two warp yarn sheets, using a set of rotating screws on opposite ends of the warp sheets and a single rotating arm that passes the yarns between the two screws as it rotates. As the screws turn, they insert the yarns extending between them into the warp sheets at a fixed number per inch to provide the desired construction. This has the effect of placing a single yarn, or multiple weft yarns, in what is termed a “square pattern” into the warp sheets. The loops in the selvage area may be removed or left intact.

Because the cross-direction yarns are not interlaced or looped around the majority of the other yarns at close spacing, the cross-direction yarns are introduced into the fabric with minimal yarn crimp. The yarns are held taut in their position to maintain the geometry of the scrim by using the selvage yarns, which ordinarily have a high tension applied to them and around which the cross-directional yarns are looped. The low yarn crimp allows the yarns to exert a high force at low elongation.

Whether the cross-directional yarns are inserted in either a square or tri-axial pattern, as described above, they are preferably permanently locked into place. This is preferably accomplished with an adhesive composition. During the initial part of fabric formation, the yarns are held in place only by friction between overlapping yarns. Typically, the construction is then transported on a conveyor from where the yarns are laid (a) over rollers directly into a chemical dip that coats the fabric with an adhesive, (b) through a nip (or set of squeeze rolls) to remove excess adhesive, and (c) over a guide roll and into an oven or over a set of steam- or oil-heated cans to dry and cure the adhesive.

It is worth noting that the warp yarn sheets may be positioned in either a staggered relationship (that is, slightly off-set from one another) or in an aligned relationship (that is, positioned directly on top of one another). In the case where the warp yarns are aligned with one another and then adhesively bonded, the effect is similar to that of a false leno pattern, and the resulting scrim layer has enhanced stability that may be desirable for some applications.

The adhesive, which is used to bind the warp yarns and cross-directional yarns to one another and which is used to bind the scrim layer(s) to the vapor permeable membrane, may be chosen from materials such as polyvinyl alcohol (PVOH), cross-linked polyvinyl alcohol, polyolefin dispersions, acrylic, polyvinyl acetate, polyvinyl chloride, polyvinylidiene chloride, polyacrylate, acrylic latex, styrene butadiene rubber (SBR), EVA, plastisol, or any other suitable adhesive. Further, these yarns optionally could be thermally bonded to form the scrim if an appropriate low-melt material is present as part of the yarn system.

In the production of adhesively bonded scrims, several variations of adhesive application may be used. For instance, the same adhesive used to bond the scrim yarns together may be used to attach the scrim to vapor permeable membrane, with the vapor permeable membrane being attached during the scrim's adhesive curing process. Alternately, the scrim layer(s) may be secured by an adhesive and may be attached in a separate process to the vapor permeable membrane with the same adhesive used to bind the yarns of the scrim layer(s). Finally, the yarns in the scrim layer(s) may be secured using the same adhesive and may be attached to the vapor permeable membrane using a different adhesive. Where multiple scrim layers are used to make the composite, like or different adhesive materials may be used to secure each respective scrim layer.

Weft-Inserted Warp Knit Scrims

Yet another means for forming a scrim useful in the present composite is to construct a fabric using a weft inserted warp knit machine, as may be available from, for instance, Liba Corporation or Mayer Corporation. Such machines are equipped with a hook or clip system at either side of the warp sheet, such that as the weft carriage introduces the yarns as it moves back and forth, the weft yarns loop around the hooks and, typically after indexing, may be inserted continuously. The weft-inserted yarns are attached to the warp sheet using a knit stitch, such as a tricot stitch, a flat stitch, or some combination thereof. With this construction, an open scrim can be formed, in which the weft yarns are inserted in a straight manner to minimize yarn crimp.

The general construction ranges previously mentioned for bi-axial adhesively bonded scrims apply to weft-inserted scrims as well. Alternately, a multi-axial warp knit scrim could also be manufactured so that the weft yarns could be laid in at an angle similarly to tri-axial scrims.

Stitch-Bonded Scrims

As a further alternate embodiment, a scrim may be formed in a similar manner to a weft inserted warp knit fabric, but which is stitch-bonded to a vapor permeable membrane, such as a nonwoven mat, or to another substrate. The attachment is made by the knitting needles that directly stitch the scrim to the vapor barrier material, as the scrim is being produced.

In one embodiment, a flexible sheet, such as a nonwoven fabric or a moisture permeable film, may be secured to the scrim as it is produced to form an intermediate composite. The flexible sheet may be comprised of a variety of materials such as a nonwoven, a moisture permeable single or multi-layer film, a woven or knit fabric layer (closed or open construction), a foam layer, a foil, a paper layer, a composite layer, and the like, depending on the properties desired in the final product. Stitch yarns are used to secure the scrim to the flexible sheet.

In a potentially preferred method of producing a composite using a stitch-bonded scrim, the scrim is stitch-bonded to a vapor permeable membrane (which may or may not already be joined to another scrim material), and the construction is then coated (for weather resistance) with a moisture-permeable coating material. Another option is that the stitch-bonded scrim is attached to a flexible sheet, which is then laminated to the vapor permeable membrane.

Alternately, a stitch-bonded composite may be formed by first producing a high elongation adhesively bonded scrim and then providing the high elongation scrim and a vapor permeable membrane, such as a nonwoven mat, into a stitch-bonding machine (such as are manufactured by Karl Mayer Malimo Textilmaschinenfabrik GmbH of Germany). Once the two composite layers are fed into the Malimo machine, low elongation yarns are used to create a scrim in situ having a warp and a weft, which are secured to one another and to the two composite layers via stitching yarns.

Yet another option is that a first scrim is produced in situ, via stitch-bonding, on a vapor permeable membrane, and the intermediate structure (membrane and stitch-bonded scrim) are then joined to a second scrim that is produced by adhesive bonding, such as was previously described.

One potential drawback with some stitch-bonding processes is that the weft yarns are not uniformly straight. When overcoming this issue is important, a weft-insert warp knitting machine having a stitch-through capability could be used. This equipment produces scrim fabrics with more regular geometry than that produced by ordinary stitch-bonding machines.

Woven Scrims

Another, but perhaps less preferred, method of making a scrim useful in the present building construction composite is by weaving. In this construction, the weft yarns are fed over and under the warp yarns. As before, the warp yarns may be of a single fiber type or of a combination of fiber types. For woven scrims, the general range of scrim constructions mentioned previously applies.

Composites

In forming the composite of the present disclosure, the scrim materials described herein may be attached to a vapor permeable membrane (e.g., a nonwoven mat) in a number of different constructions, as will be discussed below with reference to FIGS. 2A-4.

In one representative process for forming a composite material, a low elongation scrim is produced using one of the methods described above. Preferably, the low elongation scrim is an adhesively bonded scrim made of fiberglass yarns. Before being transported into a heating oven or over a set of heated cans for curing, the low elongation scrim is mated with a vapor permeable membrane (such as a nonwoven mat). It may be preferable to heat-stabilize the nonwoven mat before securing to the low elongation scrim, depending on the materials used to form the nonwoven mat. By subjecting the nonwoven mat to heat-stabilization, the nonwoven mat is set to its approximate final dimensions before contacting the low elongation scrim, thereby promoting adequate adhesion between the two layers. An intermediate composite, consisting of the nonwoven web and the low elongation scrim, is produced after curing.

Separately, a high elongation scrim is produced, preferably using a process similar to that described for the low elongation scrim, but using polyester yarns instead of glass yarns. In this instance, before the adhesive composition on the high elongation scrim is cured, the high elongation scrim is mated with the intermediate composite for transport into the heating oven or over heated cans. Whereas a heat-stabilization step may be desirable with respect to the nonwoven mat described previously, no such step is believed to be necessary when the intermediate composite is attached to the high elongation scrim.

Turning now to the FIGURES, FIG. 2A shows a first embodiment produced in accordance with the process described above. In this embodiment, a low elongation (e.g., glass) scrim layer 40 is positioned in contact with a nonwoven mat 50, and a high elongation (e.g., polyester) scrim layer 30 is further positioned in contact with low elongation scrim layer 40 to form composite 200.

In an alternate version of this embodiment where two scrim layers are applied to the same side of a nonwoven mat, high elongation scrim layer 30 is positioned in contact with nonwoven mat 50, and low elongation scrim layer 40 is positioned in contact with high elongation scrim layer 30, as shown in FIG. 2B. To produce composite 210, high elongation scrim layer 30 is attached to nonwoven mat 50 in the first step described above, and the low elongation scrim layer 40 is then attached to the high elongation scrim layer 30.

It is preferable that the scrim layer (30 or 40) that is attached to nonwoven mat 50 has a greater surface area than the non-adjacent scrim layer to promote adhesion between the components. It is also to be understood that scrim layers having the same construction may be positioned in alignment with one another or in staggered relation to one another.

Preferably, the low elongation (e.g., glass) yarns are positioned in the scrim such that, when the composite is used as a housewrap, the low elongation yarns are in a vertical position. For instance, if the housewrap is wrapped vertically from the lower framing members to the upper framing members as contemplated herein, then the low elongation yarns are used preferably at least in the warp direction. However, if the housewrap is wrapped horizontally around the house, then the low elongation yams are used preferably at least in the weft direction.

In yet another version of the first embodiment, which is shown in FIG. 2C, nonwoven mat 50 is attached to low elongation scrim layer 40. A second low elongation scrim layer 40 and a high elongation scrim layer 30 are also attached, forming a multi-layer composite material 220. The production of composite 220 is accomplished using a process similar to that described above, except that the second low elongation scrim 40 would be attached to the intermediate composite before the final step of attaching a high elongation scrim 30.

For most scrim constructions described herein, an alternate embodiment may be obtained by using a combination of low elongation yarns 10 and high elongation yarns 12, as shown in FIG. 3, to produce composite 230. Using this approach, a scrim having both strength and flexibility is produced. Ideally, the high elongation yarns 12 are heat-stabilized before being incorporated into the scrim construction to minimize differential shrinkage (leading to puckering) when the scrim is secured to the nonwoven mat 50.

In yet another embodiment, nonwoven mat 50 is positioned between high elongation scrim layer 30 and low elongation scrim layer 40, as shown in FIG. 4, to produce composite 240. To produce composite 240, a low elongation scrim 40 is attached to a nonwoven mat 50, as described previously, to form an intermediate composite. Rather than rolling up the intermediate composite with scrim layer 40 on the top, it is rolled up with nonwoven mat 50 on the top. When high elongation scrim layer 30 is prepared, high elongation scrim layer 30 is attached to nonwoven mat 50 and then cured to set the adhesive.

There are other variations contemplated for incorporating scrims into a composite structure. For instance, rather than dipping the scrim yarns into an adhesive composition, a thermoplastic adhesive could be applied to the yarns and then re-activated (using a hot calender roll, heated cans, or the like) when the scrim is attached to the nonwoven mat. Alternately, the scrim layer could be formed and cured separately from the attachment of the nonwoven mat. In this instance, a second coating of the same or a different adhesive may be applied to the scrim layer, which scrim layer is then contacted with the nonwoven mat and cured.

While embodiments have been described using adhesively bonded scrims, it should be understood that other scrim constructions may also be used, which may be attached in different ways, including, without limitation, ultrasonic sealing or welding, stitching, and other methods known in the art. For example, a scrim fabric may be made using a co-extruded, bi-component yarn, where one component of the yarn itself is capable of melting and securing the scrim to the nonwoven mat. This may be particularly useful where the melting component and the nonwoven mat are made from the same material. Alternately, using other scrim types (e.g., knits or wovens), the scrim component(s) and the nonwoven web may be secured using adhesive films or powders to laminate the layers together. These adhesives may be heat-activated or curable at room temperature.

Further, it should also be understood that while representative embodiments having multiple adhesively bonded scrim layers have been described, there is no requirement that the scrim layers be formed from the same process, that the scrim layers have the same construction, or that the scrim layers be secured with the same adhesive.

Finally, although the present composite has been described in the form of a continuously produced roll, it is contemplated that the scrim layers may be cut into panels of a desired dimension and aligned such that the warp yarns of a first scrim layer are perpendicular to the warp yarns of a second scrim layer. Such panels may facilitate building construction for some applications.

### EXAMPLE

An adhesively bonded tri-axial scrim was made using G-37 fiberglass yarns. This low elongation tri-axial scrim had a 7×3.5×3.5 construction (7 ends per inch in the warp direction, 3.5 ends per inch in the upward diagonal slope in the weft direction, and 3.5 ends per inch in the downward diagonal slope in the weft direction). The fiberglass yarns were laid on a conveyor and transported through a bath containing a cross-linked polyvinyl alcohol adhesive composition.

The wet fiberglass scrim material was conveyed through nip rolls to remove excess adhesive and was then mated with a heat-stabilized nonwoven mat made of spun-bonded polypropylene attached to a polypropylene film. The weight of the nonwoven mat was about 2.85 ounces/yd².

With the adhesive pick-up on the low elongation scrim being about 10-12% of its total weight, the weight of the intermediate composite (low elongation scrim and nonwoven mat) was about 5.85 ounces/yd². The intermediate composite was passed through a series of heated cans at a temperature of between 150° F. and 170° F. on the majority of the cans, and the cured intermediate composite was taken up on a roll with the low elongation scrim to the outside.

In a second pass, another adhesively bonded scrim fabric was made using 1000-denier polyester yarns. This high elongation tri-axial scrim had an 8×1×1 construction (8 ends per inch in the warp direction, 1 end per inch in the upward diagonal slope in the weft direction, and 1 end per inch in the downward diagonal slope in the weft direction). The polyester yarns were laid on a conveyor and transported through a bath containing the same cross-linked polyvinyl alcohol adhesive composition used to form the fiberglass scrim.

The wet polyester scrim material was conveyed through nip rolls to remove excess adhesive and was then mated with the intermediate composite made of a polypropylene mat attached to a fiberglass scrim. The scrim layers were positioned in contact with one another, such that there was staggered alignment between the warp yarns of the fiberglass scrim and the warp yarns of the polyester scrim.

The composite layers were passed through a series of heated cans at a temperature of between 150° F. and 170° F. on the majority of the cans, and the cured composite was taken up on a roll. The average weight of the finished composite was 7.34 ounces per square yard. It was observed that the composite layers were secured stably to one another.

Using Grab Tensile Test ASTM D-5034, the tensile strength of the composite was measured in the machine direction and the cross-machine direction. In the machine direction, the composite exhibited a tensile strength of 211 pounds per inch and an elongation at break of 10.9%. In the cross-machine direction, the composite exhibited a tensile strength of 160 pounds per inch and an elongation at break of 10.9%.

1. A composite comprising:
a first scrim layer, said first scrim layer being comprised of high elongation yarns;
a second scrim layer, said second scrim layer being comprised of low elongation yarns; and
a vapor permeable membrane, said vapor permeable membrane being attached to at least one of said first scrim layer and said second scrim layer.

2. The composite of claim 1, wherein said first scrim layer is an adhesively bonded scrim.

3. The composite of claim 2, wherein said first scrim layer is a tri-axial scrim.

4. The composite of claim 1, wherein said first scrim layer is a stitch-bonded scrim.

5. The composite of claim 1, wherein said first scrim layer is made of yarns selected from the group consisting of fiberglass, ceramic, basalt, carbon, aramid, metal, and combinations thereof.

6. The composite of claim 5, wherein said first scrim layer is made of fiberglass yarns.

7. The composite of claim 1, wherein said second scrim layer is an adhesively bonded scrim.

8. The composite of claim 7, wherein said second scrim layer is a tri-axial scrim.

9. The composite of claim 1, wherein said second scrim layer is a stitch-bonded scrim.

10. The composite of claim 1, wherein said second scrim layer is made of yarns selected from the group consisting of polyester, polyamide, polyolefin, and combinations thereof.

11. The composite of claim 10, wherein said second scrim layer is made of polyester yarns.

12. The composite of claim 1, wherein said first scrim layer is adhesively bonded to said vapor permeable membrane and said second scrim layer is adhesively bonded to said first scrim layer.

13. The composite of claim 12, wherein a third scrim layer is adhesively bonded between said first scrim layer and said second scrim layer, said third scrim layer being comprised of low elongation yarns.

14. The composite of claim 1, wherein said second scrim layer is adhesively bonded to said vapor permeable membrane and said first scrim layer is adhesively bonded to said second scrim layer.

15. The composite of claim 1, wherein said first scrim layer is adhesively bonded to a first side of said vapor permeable membrane and said second scrim layer is adhesively bonded to an opposite side of said vapor permeable membrane.

16. The composite of claim 1, wherein said first layer is a stitch-bonded scrim and said second layer is an adhesively bonded scrim, said first layer being stitched to said vapor permeable membrane and said second layer being adhesively bonded to said first layer.

17. The composite of claim 1, wherein said vapor permeable membrane is a nonwoven mat.

18. A composite comprising:
a scrim layer having warp and weft yarns, wherein one of said warp and said weft yarns comprises high elongation yarns and another of said warp and weft yarns comprises low elongation yarns; and
a vapor permeable membrane;
wherein said scrim layer is attached to said vapor permeable membrane.

19. The composite of claim 18, wherein said scrim layer is an adhesively bonded scrim.

20. The composite of claim 18, wherein said scrim layer is a tri-axial scrim.

21. The composite of claim 18, wherein said scrim layer is a stitch-bonded scrim.

22. The composite of claim 18, wherein said high elongation yarns are selected from the group consisting of polyester, polyamides, polyolefins, and combinations thereof.

23. The composite of claim 22, wherein said high elongation yarns are polyester.

24. The composite of claim 18, wherein said low elongation yarns are selected from the group consisting of fiberglass, ceramic, basalt, carbon, aramid, metal, and combinations thereof.

25. The composite of claim 24, wherein said low elongation yarns are fiberglass.

26. The composite of claim 18, wherein said vapor permeable membrane is a nonwoven mat.
